(19) United States
(12) Patent Application Publication
(10) Pub. No.: US 2012/0143885 A1
(43) Pub. Date: Jun. 7, 2012

(54) HYBRID SOURCES PREREADY DETERMINATION

(75) Inventors: Emil Talpes, Sunnyvale, CA (US); Ganesh Venkataramanan, Sunnyvale, CA (US)

(73) Assignee: ADVANCED MICRO DEVICES, INC., Sunnyvale, CA (US)

(21) Appl. No.: 12/957,788

(22) Filed: Dec. 1, 2010

(51) Int. Cl. G06F 17/30

(52) U.S. Cl. 707/756; 707/E17.002

(57) ABSTRACT

A method and apparatus for maintaining source ready information are disclosed. A first copy of the source ready information is stored in an Architectural Register Name (ARN)-indexed structure and a second copy of the source ready information is stored in a Physical Register Number (PRN)-indexed structure. As new instructions become available that require at least one source, the ARN-indexed structure is accessed. If at least one new source becomes available, the ARN-indexed structure and the PRN-indexed structure are updated to include information regarding the new sources.

### FIELD OF INVENTION

The present invention relates to computer processors, and more particularly, to maintaining Source Ready information in architectural and physical registers.

### BACKGROUND

In computer architecture, registers provide a way for a processor, such as the central processing unit (CPU), to quickly access data. One type of register is an architectural register. Architectural registers may be directly encoded as part of an instruction, as defined by the instruction set. Each instruction requires a number of sources, which may also be referred to as operands. For example, in an instruction to add ‘a’ and ‘b,’ ‘a’ and ‘b’ are the sources for the instruction. A particular source may either be ready or not ready. For example, a source may still be in the processor and not yet in the register, and thus not ready. Determining whether sources are ready may be accomplished after the instructions are decoded, but before the instructions are written to the scheduler.

Register renaming may make use of an additional type of register, a physical register. Sources may be maintained in and accessed from the physical registers. To associate the physical registers with the architectural registers, a mapping may be maintained between the architectural registers and the physical registers.

An architectural register may be accessed based on its Architectural Register Name (ARN). A physical register may be accessed based on its Physical Register Number (PRN). An ARN must be renamed to a corresponding PRN before a physical register can be accessed based on the PRN. Thus, PRN-indexed structures are available only after renaming. Conversely, ARN-indexed structures may be available before renaming because the ARN references the actual source and the location of the actual source is included in the instruction.

Upon receiving instructions, the processor may need to determine which operands have already been computed for the instructions before they are written into the scheduler. Two approaches may be used to make this determination: an ARN-based approach or a PRN-based approach.

The ARN-based approach includes maintaining Source Ready information associated with each architectural register. This allows the information to be accessed early in the life or processing of an instruction. Accessing this information early may allow instructions to be executed more quickly, thus saving time. But, a disadvantage to the ARN-based approach is that information may be lost when discontinuities are detected in the instruction stream. Examples of discontinuities include, for example, branch mispredictions or exceptions. If a discontinuity occurs, the ARN-to-PRN mapping may change and the Source Ready information may become inconsistent. This problem may be resolved by considering that all operands are ready to be accessed. But, such an approach may lead to lower performance and/or higher power consumption.

The PRN-based approach includes maintaining Source Ready information associated with each physical register. Because the information is not maintained in an architectural register, the information may remain available after instruction flow discontinuities. A disadvantage to the PRN-based approach is the delay associated with accessing the physical registers. Source Ready information maintained in physical registers may only be accessed after an ARN-to-PRN translation, which may delay the execution of the instruction by one cycle.

These approaches require a design choice that results in a tradeoff between access time and possible information loss. The ARN-based approach allows for higher speed due to the shorter access time. But the ARN-based approach is not robust and allows information to be lost. The PRN-based approach allows for a robust design, such that information remains available after discontinuities. But the PRN-based approach may delay the execution of the instruction by one cycle due to the translation delay.

### SUMMARY OF EMBODIMENTS

A method for maintaining source ready information for a processor begins by maintaining a first copy of the source ready information in an ARN-indexed structure and maintaining a second copy of the source ready information in a PRN-indexed structure. As new instructions become available that require at least one source, the ARN-indexed structure is accessed. If at least one new source becomes available, the ARN-indexed structure and the PRN-indexed structure are updated to include information regarding the new sources.

An apparatus for maintaining source ready information includes an ARN-indexed structure and a PRN-indexed structure. The ARN-indexed structure is configured to maintain a copy of source ready information, provide source ready information if an instruction requires at least one source, and store source ready information if at least one new source becomes available. The PRN-indexed structure is configured to maintain a copy of source ready information and store source ready information if at least one new source becomes available.

A computer readable storage medium storing a set of instructions for execution by one or more processors to maintain source ready information includes a first storing code segment, a second storing code segment, an accessing code segment, and an updating code segment. The first storing code segment maintains a copy of source ready information indexed by ARN. The second storing code segment maintains a copy of source ready information indexed by PRN. The accessing code segment accesses the source ready information indexed by ARN if an instruction requires at least one source. The updating code segment updates the source ready information indexed by ARN and source ready information indexed by PRN if at least one new source becomes available.

### BRIEF DESCRIPTION OF THE DRAWINGS

A more detailed understanding of the invention may be had from the following description, given by way of example, and to be understood in conjunction with the accompanying drawings, wherein:

FIG. 1 shows an example of an ARN-based structure;

FIG. 2 shows an example of a PRN-based structure;

FIG. 3 shows an overview of the interaction between the front end, the map, and the back end of a processor;

FIG. 4 is a flow diagram of a method for maintaining and accessing Source Ready information using a hybrid approach; and

FIG. 5 shows an example of retrieving Source Ready bits from a PRN-indexed table following an instruction flow discontinuity in a portion of a processor.

### DETAILED DESCRIPTION

The following describes an enhancement for determining which operands have already been computed for instructions before they are written in the scheduler. Traditionally, either an ARN-based approach or a PRN-based approach was used to maintain Source Ready information. Thus, according to the traditional approach, when new sources become available, information related to the source is maintained in one structure that is indexed by either ARN or PRN. A hybrid approach may be used to achieve the speed benefits of an ARN-based approach, while maintaining the robustness of a PRN-based approach. The hybrid approach includes maintaining two copies of the Source Ready information. A first copy of the Source Ready information may be in a format accessible by ARN. A second copy of the Source Ready information may be in a format accessible by PRN. When Source Ready information is needed, a structure indexed by ARN is accessed to retrieve the information. The access is performed quickly because accessing information from an ARN-indexed structure is quicker than accessing information from a PRN-indexed structure. If the information in the ARN-indexed structure is lost at any time, then the information in the PRN-indexed structure will likely be available because the PRN-indexed structure is more robust than the ARN-indexed structure. The Source Ready information may then be translated from the PRN-indexed structure and used to restore the information in the ARN-indexed structure. In this way, the speed benefits of the ARN-based approach are achieved while a robust copy of the information is also maintained in a PRN-indexed structure.

An ARN-based structure used in the hybrid approach may include a relatively small number of registers. For example, the ARN-based structure may include approximately 32 registers, of which 16 registers may be re-generable. Each register may be certified by the instruction set. The ARN-based structure may be accessed based on a 5-bit ARN field.

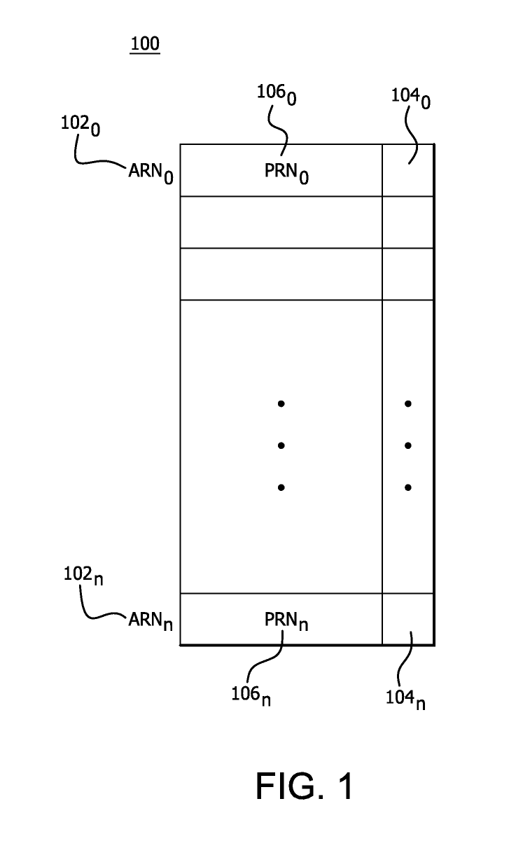

FIG. 1 shows an example of an ARN-based structure 100. Each row of the ARN-based structure 100 corresponds to a particular ARN 102₀-102ₙ (ranging from ARN₀ to ARNₙ). The ARN-based structure 100 maintains one Ready bit 104₀-104ₙ per ARN. For example, the Ready bit 104₀-104ₙ is ‘1’ if the source corresponding to that particular ARN is ready and is ‘0’ if the source corresponding to that particular ARN is not ready.

A PRN-based structure used in the hybrid approach may include a relatively large number of registers. The number of registers may, for example, be greater than 32 registers. As an additional example, the number of registers may be on the order of 90-110 registers. The PRN-based structure may be accessed based on a 7-bit PRN field. Access to the PRN-based structure may only be available after renaming, which may be one cycle later than access is available to an ARN-based structure.

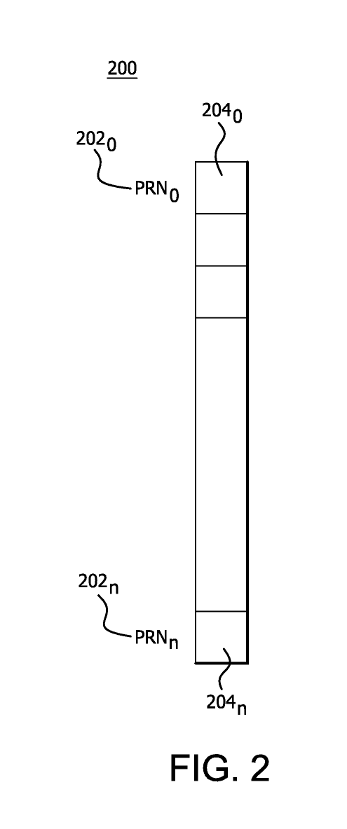

FIG. 2 shows an example of a PRN-based structure 200. Each row of the PRN-based structure 200 corresponds to a particular PRN 202₀-202ₙ (ranging from PRN₀ to PRNₙ). The PRN-based structure 200 may be a vector with one entry 204₀-204ₙ per PRN 202₀-202ₙ. For example, the entry 204₀-204ₙ may be one Ready bit, which is ‘1’ if the source corresponding to that particular PRN is ready and is ‘0’ if the source corresponding to that particular PRN is not ready.

Referring again to FIG. 1, the column adjacent to the Ready bit 104₀-104ₙ may be used as a translation table and may hold the corresponding PRNs 106₀-106ₙ associated with particular ARNs 102₀-102ₙ. The Ready bit 104₀-104ₙ for each ARN 102₀-102ₙ indicates whether the source is ready for the PRNs 106₀-106ₙ associated with each ARN 102₀-102ₙ. Thus, each Ready bit 104₀-104ₙ associated with PRNs 106₀-106ₙ in the ARN-based structure corresponds to the Ready bit 204₀-204ₙ associated with the same PRN 202₀-202ₙ in the PRN-based structure.

For a given instruction sequence, ARNs may need to be translated into PRNs. For each source, the translation table holding the corresponding PRNs 106₀-106ₙ may need to be consulted to perform the translation from ARN to PRN. Using an ARN-based Source Ready scheme, the Ready bit 104₀-104ₙ may be obtained from the ARN-based structure 100 at the same time that the corresponding PRN 106₀-106ₙ may be obtained because the table is indexed by ARN. When using a PRN-based Source Ready scheme, translation may first be necessary, meaning that the corresponding PRN 106₀-106ₙ may have to be obtained first. Then, the entry 204₀-204ₙ in the PRN-based structure 200 may be accessed to determine whether the source is ready. This additional access may consume an extra cycle of pipeline time.

Updating ARN-based structures and PRN-based structures may be accomplished separately and in a different manner. Writing to a register may be specified by PRN. Thus, PRN-based structures may be directly written to because the physical register is known. Conversely, ARN-based structures may require access and a mapping to the PRN indices to determine which register to write to. Thus, the ARN-based structure may require an “associated look-up” before it is updated. Therefore, a hybrid approach may also require associated look-ups because both an ARN-indexed table and a PRN-indexed table may be used as the ARN-based structure and the PRN-based structure, respectively.

As an example, the ARN-indexed table may be a 32-bit structure and the PRN-indexed table may be a 100-bit structure. The ARN-indexed table may be updated based on instructions for execution. The PRN-indexed table may be updated based on actual execution. The PRN-indexed table may be used only if a discontinuity occurs. If a discontinuity does occur, it may take several cycles to recreate the ARN-indexed table from the PRN-indexed table. For example, 32 pieces of logic may be executed in one cycle. Depending on the number of pieces of logic, it may take multiple cycles to recreate the instructions that were lost due to the discontinuity. Because recreating the instructions may be mandatory and the time to recreate the ARN-indexed table may be less than the time to recreate instructions, no additional time may be required to recreate the ARN-indexed table. In this way, the time to recreate the ARN-indexed table may be “hidden” with respect to the time to recreate the instructions.

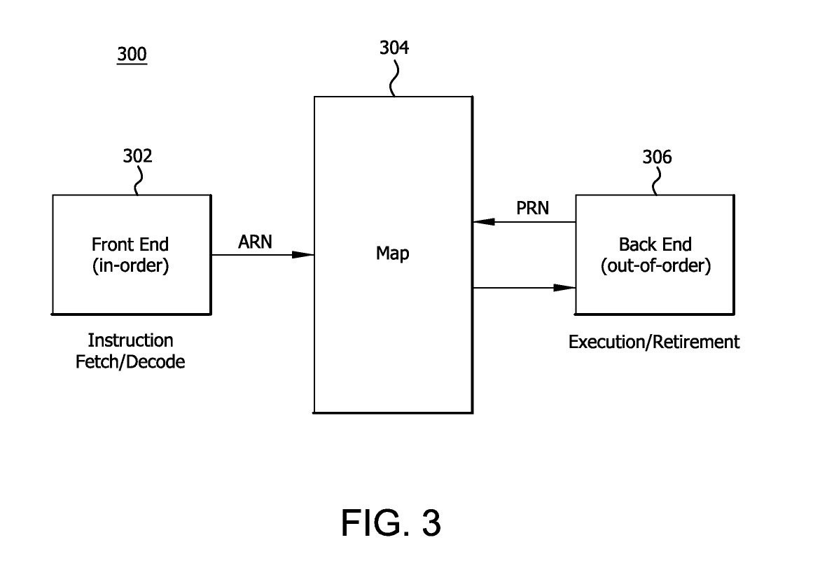

FIG. 3 shows an overview 300 of the interaction between the in-order (“front end”) 302 of the processor, the map 304, and the out-of-order execution core (“back end”) 306. The front end 302, which performs instruction fetch and decode, may only have knowledge of ARNs. The front end 302 provides the map 304 with information related to ARNs. The map 304 may be used to establish and maintain correspondence between the front end 302 and the back end 306. The map 304 contains information related to the ARNs provided by the front end 302 and information related to PRNs provided by the back end 306. The back end 306 may only have knowledge of PRNs and may provide information related to PRNs to the map 304.

Source Ready information may need to be updated (set or reset) when Pick/Reset requests are received. Pick/Reset values come to the back end 306 as PRNs and not as ARNs. A PRN-indexed structure is indexed by PRN values, so the Pick/Reset request is straight-forward in a PRN-based scheme. In an ARN-based scheme, comparators (CAMs) are required between each Pick/Reset request and each entry in the map 304 because the Pick/Reset requests are received as PRNs and the ARN-based scheme is indexed by ARN. Thus, when a PRN is received and Source Ready information needs to be updated (set or reset), the corresponding ARN must be determined. The map 304 maintains the correspondence between ARNs and PRNs as a dedicated table, so the PRN fields in the map 304 are compared with the received PRN. If the PRN matches any record that it is compared to, the Source Ready information is updated for the corresponding ARN.

A table indexed by ARN and a table indexed by PRN may be used as the ARN-based structure and the PRN-based structure, respectively, to maintain two copies of the Source Ready information used in the hybrid approach. If new operands become available, the ARN-indexed table and the PRN-indexed table may both be updated. If an instruction is written to the scheduler, the ARN-indexed table may be accessed. A mapping may be maintained between the ARNs and the PRNs. For example, the ARN-indexed table may include the PRN corresponding to a particular ARN. If an instruction flow discontinuity occurs, the ARN-to-PRN mapping may become invalid, and may need to be restored.

Correcting the ARN-to-PRN mapping may be accomplished, for example, by loading the correct mapping from a Checkpoint Table or by traversing a Retire Buffer (which may also be referred to as a “Reorder Buffer”). If a Checkpoint Table is used, the contents of the map are saved in the Checkpoint Table periodically, for example, whenever a branch prediction is made. If the branch prediction is incorrect, a correct mapping is retrieved using the map that was saved when the incorrect branch prediction was made. If a Checkpoint Table is not used, the ARN information must be maintained as every instruction is executed, so that the mapping may be restored at a later time. For example, this information may be written into a Retire Buffer on a per-instruction basis. If an incorrect branch prediction occurs, the instruction records from the Retire Buffer are read one at a time. Any records in the map that were changed by the instruction are updated.

Upon restoring the correct ARN-to-PRN mapping, the PRN-indexed table may be accessed and read. The information contained in the PRN-indexed table may be translated back into the ARN-indexed table. Until this translation is performed, new instructions may not be able to be added back to the scheduler. Upon completing the translation, new instructions may be added back to the scheduler. This ensures that the correct Source Ready information is received.

The translation may require an additional delay, which may be concurrent with the delay associated with retrieving correct instructions following a discontinuity. Thus, the translation delay may be hidden under the minimal delay associated with fetching the correct instructions.

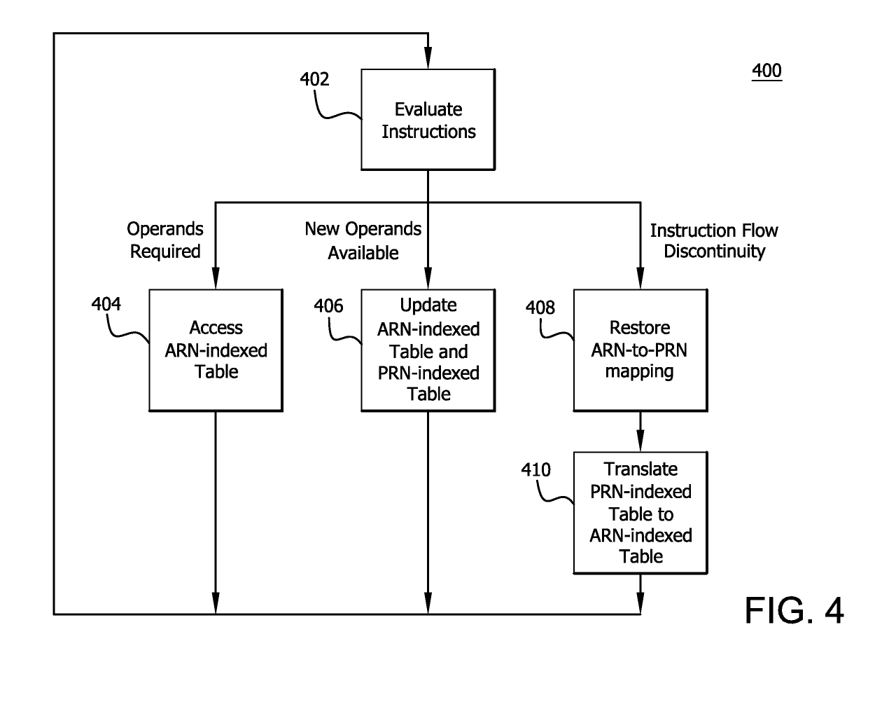

FIG. 4 is a flow diagram of a method 400 for maintaining and accessing two copies of Source Ready information in an ARN-indexed table and a PRN-indexed table. The method 400 includes evaluating instructions that are written into the scheduler (step 402). If instructions that require operands are written into the scheduler, the ARN-indexed table is accessed (step 404) to retrieve the status of the operands required by the instructions. If new operands become available, both the ARN-indexed table and the PRN-indexed table are updated with the status of the new operands (step 406). The PRN-indexed table may be directly written to because writing to a register is specified by the PRN. An associated lookup may need to be performed before writing to the ARN-indexed table because the ARN corresponding to a given PRN may need to be determined.

If an instruction flow discontinuity occurs, the ARN-to-PRN mapping needs to be restored (step 408). The information from the PRN-indexed table is then translated back into the ARN-indexed table (step 410). Steps 402-410 may overlap, such that other instructions may be evaluated while operands are read from and written to the appropriate table.

If an instruction flow discontinuity occurs, a “flush” of the instruction stream may follow and the ARN-to-PRN mapping may no longer be valid. To restore the ARN-to-PRN mapping, a number of PRNs may be selected each cycle and be indexed into the PRN-indexed table. The Source Ready information may then be obtained from the PRN-indexed table to restore the ARN-to-PRN mapping.

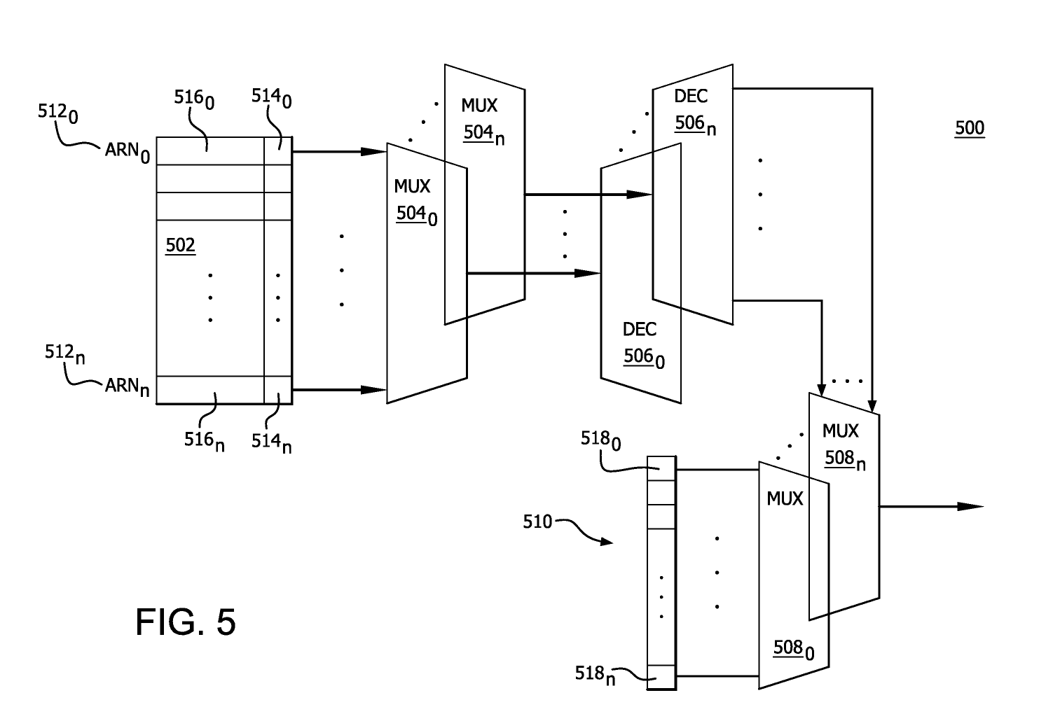

FIG. 5 shows an example of the process of retrieving Source Ready bits from a PRN-indexed table following a flush triggered by an instruction flow discontinuity in a portion of a processor 500. The components that may be accessed or used following an instruction flow discontinuity include an ARN-indexed table 502, a first plurality of multiplexors (MUXes) 504₀-504ₙ, a plurality of decoders 506₀-506ₙ, a second plurality of MUXes 508₀-508ₙ, and a PRN-indexed table 510. The ARN-indexed table 502 may serve as the map, containing the correct correspondence between ARNs and PRNs. Each row of the ARN-indexed table 502 may correspond to a particular ARN 512₀-512ₙ (ranging from ARN₀ to ARNₙ). The ARN-indexed table 502 maintains one Ready bit 514₀-514ₙ per ARN. The column adjacent to the Ready bit 514₀-514ₙ is used as a translation table or map and may hold the corresponding PRNs 516₀-516ₙ associated with particular ARNs 512₀-512ₙ. Each cycle, a predetermined portion of the PRNs 516₀-516ₙ may be selected from the ARN-indexed table 502 and used to obtain the Source Ready information from the PRN-indexed table 510. The PRN-indexed table 510 maintains one Ready bit 518₀-518ₙ per PRN.

To obtain the Source Ready information from the PRN-indexed table 510 that is used to update the ARN-indexed table 502, the predetermined portion of the PRNs 516₀-516ₙ may be selected by the first plurality of MUXes 504₀-504ₙ. For example, if 32 PRNs are contained in the translation table, eight MUXes (4:1) may be used. The values obtained from the first plurality of MUXes 504₀-504ₙ are decoded by the plurality of decoders 506₀-506ₙ. For example, eight decoders (7:128) may be used. The resulting values are used as read addresses for the PRN-indexed table 510. These values obtained from the plurality of decoders 506₀-506ₙ are used by the second plurality of MUXes 508₀-508ₙ. For example, eight MUXes (128:1) may be used. The resulting values obtained from the second plurality of MUXes 508₀-508ₙ are the Source Ready bits required to update the Ready bits 514₀-514ₙ of the ARN-indexed table. Thus, the appropriate Ready bits 514₀-514ₙ associated with particular ARNs 512₀-512ₙ are then updated in the ARN-indexed table 502.

Although features and elements are described above in particular combinations, each feature or element may be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of processors, one or more processors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions (such instructions capable of being stored on a computer readable media). The results of such processing may be maskworks that are then used in a semiconductor manufacturing process to manufacture a processor which implements aspects of the present invention.

What is claimed is:

1. A method for maintaining source ready information for a processor, comprising:
maintaining a first copy of the source ready information in an Architectural Register Name (ARN)-indexed structure;
maintaining a second copy of the source ready information in a Physical Register Number (PRN)-indexed structure;
accessing the ARN-indexed structure if an instruction requires at least one source; and
updating the ARN-indexed structure and the PRN-indexed structure if at least one new source becomes available.

2. The method according to claim 1, further comprising:
maintaining a mapping between the ARN-indexed structure and the PRN-indexed structure.

3. The method according to claim 2, wherein the mapping is maintained in the ARN-indexed structure.

4. The method according to claim 3, further comprising:
restoring the mapping between the ARN-indexed structure and the PRN-indexed structure by translating source ready information into the ARN-indexed structure from the PRN-indexed structure if an instruction flow discontinuity occurs.

5. The method according to claim 4, wherein the restoring further includes using a checkpoint table to save the contents of the mapping at predetermined time intervals.

6. The method according to claim 4, wherein the restoring further includes traversing a retire buffer to retrieve information regarding each instruction that has been processed since an instruction that led to an incorrect branch prediction.

7. The method according to claim 1, wherein the ARN-indexed structure includes:
a portion configured to store one source ready bit per ARN; and
a portion configured to store a PRN associated with each ARN.

8. The method according to claim 1, wherein the PRN-indexed structure is a vector that includes a portion configured to store one source ready bit per PRN.

9. An apparatus for maintaining source ready information, comprising:
an Architectural Register Name (ARN)-indexed structure configured to maintain a first copy of the source ready information;
a Physical Register Number (PRN)-indexed structure configured to maintain a second copy of the source ready information;
the ARN-indexed structure is further configured to:
provide the source ready information if an instruction requires at least one source; and
store the source ready information if at least one new source becomes available; and
the PRN-indexed structure is further configured to store the source ready information if at least one new source becomes available.

10. The apparatus according to claim 9, further comprising:
a map configured to maintain a mapping between the ARN-indexed structure and the PRN-indexed structure.

11. The apparatus according to claim 10, wherein the map is included in the ARN-indexed structure.

12. The apparatus according to claim 11, wherein the map is further configured to restore the mapping between the ARN-indexed structure and the PRN-indexed structure by translating the source ready information from the PRN-indexed structure to the ARN-indexed structure if an instruction flow discontinuity occurs.

13. The apparatus according to claim 12, further comprising:
a checkpoint table configured to save the contents of the map at predetermined time intervals.

14. The apparatus according to claim 12, further comprising:
a retire buffer configured to:
store information regarding each instruction that has been processed; and
provide information regarding each instruction that has been processed since an instruction that led to an incorrect branch prediction.

15. The apparatus according to claim 9, wherein the ARN-indexed structure includes:
a portion configured to store one source ready bit per ARN; and
a portion configured to store a PRN associated with each ARN.

16. The apparatus according to claim 9, wherein the PRN-indexed structure is a vector that includes a portion configured to store one source ready bit per PRN.

17. A computer-readable storage medium storing a set of instructions for execution by one or more processors to maintain source ready information, the set of instructions comprising:
a first storing code segment for maintaining a first copy of the source ready information indexed by Architectural Register Name (ARN);
a second storing code segment for maintaining a second copy of the source ready information indexed by Physical Register Number (PRN);
an accessing code segment for accessing the source ready information indexed by ARN if an instruction requires at least one source; and
an updating code segment for updating the source ready information indexed by ARN and source ready information indexed by PRN if at least one new source becomes available.

18. The computer-readable storage medium according to claim 17, wherein the set of instructions are hardware description language (HDL) instructions used for the manufacture of a device.
